(19) United States
(12) Patent Application Publication
(10) Pub. No.: US 2006/0103762 A1
(43) Pub. Date: May 18, 2006

(54) Interactive imaging apparatus and method of operation thereof

(76) Inventors: Ha M. Ly, Boynton Beach, FL (US); Theresa T. Pham, Lake Worth, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/992,344

(22) Filed: Nov. 18, 2004

(51) Int. Cl. H04N 9/74

(52) U.S. Cl. 348/584

(57) ABSTRACT

An interactive imaging apparatus (100) includes a user interactive component (115), a subject interactive component (130), and an image capture device (145). The subject interactive component (130) provides one or more prompts (135) to a subject (110) in response to a prompt command from the user interactive component (115). The image capture device (145) captures a subject image in response to an image capture command from the user interactive component (115).

### BACKGROUND OF THE INVENTION

1. Field of the Invention

The present invention is in general related to portable electronic devices; and in particular related to portable electronic devices with image capture capability.

2. Description of the Related Art

Portable electronic devices are a prevalent part of life today. Portable electronic devices such as personal digital assistants (PDAs), cellular telephones, compact disc players (CD's), digital video disc players (DVD's), digital cameras, hand-held games, and the like have become market staples and are continuously being upgraded, combined, and improved upon. The integration of these devices with each other and other technological capabilities has created a range of portable and multifunctional electronic devices.

As portable electronic devices continue to evolve, the multifunctional capabilities continue to expand. One such capability is connectivity to imaging devices such as still-image and video cameras. For example, there are still-image and video camera accessories that can be connected to a cellular telephone or other similar portable electronic device. Many such devices have displays for viewing images, text, data, and the like. Some devices further provide capability to receive images such as photographs taken by other electronic devices. One example is a cellular telephone capable of receiving a photograph from a personal computer or from another portable electronic device. Further, some manufacturers are offering portable electronic devices with built-in imaging capability including still image and/or video cameras. Once the images are stored on the portable electronic device, the device user can view them on a display and utilize the images in other available applications such as backgrounds, standby screens, contact lists, and the like.

Another multifunctional capability in the market today, is the ability for video cameras to sense motion and in response simultaneously emit an alert, notifying a person that his/her photograph is being taken. This technology is being used by law enforcement agencies and the like for surveillance purposes.

It is desirable to enhance the functionality of portable communication devices.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates an interactive imaging apparatus in accordance with the present invention;

FIGS. 2 through 7 illustrate exemplary embodiments of a portable electronic device incorporating the interactive imaging apparatus in accordance with the present invention;

FIG. 8 is an electrical block diagram of a communication device incorporating the interactive imaging apparatus of FIG. 1; and

FIGS. 9 through 11 are flow charts illustrating various exemplary operations of a portable electronic device equipped with the interactive imaging apparatus of FIG. 1.

### DETAILED DESCRIPTION

In accordance with the present invention, there is provided herein an apparatus and method for providing enhanced functionality and usability of image capturing means through the integration of various image capture-related prompt indications. In general, a device alerts a subject prior to capturing the subject's image using audible, vibratory, visual, and haptic alert prompts. The prompts can be, for example, pre-recorded voice messages, icons, text, and/or animated images viewable by the subject. In summary, image capture capability is combined with audible, vibratory, visual, and haptic alert prompts to provide enhanced functionality.

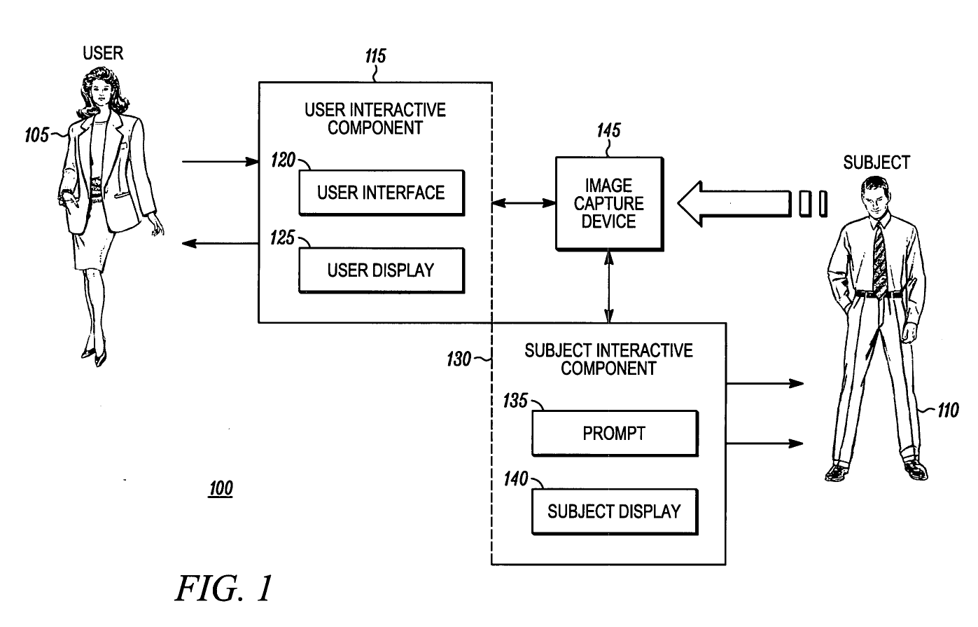

Referring to FIG. 1, in accordance with the present invention, an interactive imaging apparatus 100 facilitating interaction between a user 105 and a subject 110 is shown. The interactive imaging apparatus 100 includes a user interactive component 115 and a subject interactive component 130.

The user interactive component 115 provides a mechanism for the user 105 to interact with an image capture feature and also an associated prompt feature. The user interactive component 115 also facilitates interaction between the user 105 and the subject 110 by providing inputs to the subject interactive component 130. The user interactive component 115, for example, includes a user interface 120 and a user display 125. The user interface 120 enables the user 105 to activate an image capture mode such as by using an image capture device 145; and also to provide one or more prompts to the subject 110. The subject's image can then be captured by the image capture device 145. The subject's image can also be displayed on the user display 125 for viewing by the user 105.

The subject interactive component 130 provides a means for the user 105 to engage the attention of the subject 110. The subject interactive component 130, for example, includes at least one prompt 135 and a subject display 140. The at least one prompt 135 alerts the subject 110, for example, to capture the subject's attention prior to taking the subject's photograph. The prompt 135 can include one or more audio, visual, vibratory, haptic or any other equivalent such alert. Visual alerts such as textual, iconic, still image, or animated image prompts can be displayed on the subject display 140. The resulting prompt 135 draws the subject's attention to the image capture device 145 and the subject's image can thereafter be captured nearly simultaneously with the alert/prompt. The captured subject image can be viewed by the subject 110 on the subject display 140; and can also be viewed by the user 105 on the user display 125. Thus, the user's communication device can be used to take a picture of a subject and also notify the subject that his or her picture is being taken. The subject can view the picture on the subject display 140 of the user's device.

The image capture device 145 facilitates image capture by its connectivity to the user interactive component 115 and the subject interactive component 130. When the image capture mode is activated via the user interface 120, the image capture device 145 captures a subject image. The subject image, for example can be a still image or a video image. It will be appreciated by those of ordinary skill in the art that the image capture device 145 can be integrated within a portable electronic device along with the user interactive component 115 and the subject interactive component 130. Alternatively, the image capture device 145 can be externally coupled to the portable electronic device and can include one or more imaging devices such as still-imaging and video cameras. For example, the image capture device 145 can include one or more still-image and/or video camera accessories that connectable to a cellular telephone.

The image capture device 145, for example, can be a camera including the necessary circuitry for providing camera functionality to the interactive imaging apparatus 100. For example, the image capture device 145 can include functionality of a digital camera having software and circuitry for the calculations that are made each time a picture is taken. The image capture device 145 provides functionality to preview, capture, compress, filter, store, transfer, and display the image. Typically, the image capture device 145 includes a microprocessor programmed to perform these calculations and other various functions.

It will be appreciated by one of ordinary skill in the art that the interactive imaging apparatus 100 of FIG. 1 as described herein can be integrated within or coupled to any portable electronic device including PDAs, cellular telephones, CD's, digital video disc players DVD's, digital cameras, hand-held games, messaging devices, personal computers or the like.

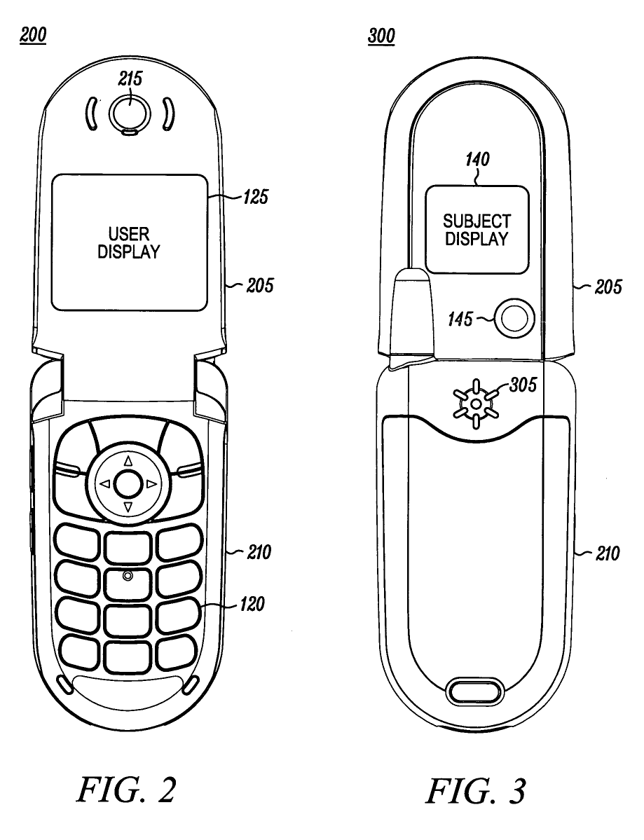

Referring to FIGS. 2 and 3, an exemplary embodiment of a portable flip-type communication device suitable for integration with the interactive imaging apparatus 100 is shown. Specifically, FIG. 2 illustrates a front view 200 of a portable flip-type communication device and FIG. 3 illustrates a back view 300 of a portable flip-type communication device. The flip-type communication device, as illustrated, comprises a base housing 210 and a flip housing 205. The flip housing 205 is preferably a hinged cover that closes to make the flip-type communication device more compact and to protect a keypad 120 or other user interface located on the base housing 210 from inadvertent entries. The flip housing 205 rotates relative to the base housing 210 in a plane perpendicular to the plane of the base housing 210. As an example, a communication device such as a radiotelephone can comprise two planar elements coupled by a hinge. When the radiotelephone is not in use, the two planar elements can be closed and lie in parallel (not shown). When the radiotelephone is in use, the two planar elements can be opened in relation to each other, exposing such elements as a touch pad, viewing screen, microphone and/or speaker.

It will be appreciated by those of ordinary skill in the art that the base housing 210 and the flip housing 205 can each have, and/or contain printed circuit boards (PCBs) with electronic components, audio devices, cameras, visual displays, and housing chassis, as well as wiring to connect the electrical component together to form electrical circuits, and the like.

By way of example, FIG. 2 illustrates a front view 200 of a flip-type cellular telephone incorporating the interactive imaging apparatus 100 of FIG. 1. In this embodiment the user display 125 is located on the front side of the flip housing 205 and the user interface 120 (i.e. a keypad as illustrated) is located on the base housing 210. A speaker device 215 for audio prompts, voice recordings and the like is located on the front side of the flip housing 205.

Further detailing the example, FIG. 3 illustrates a back view 300 of a flip-type cellular telephone incorporating the interactive imaging apparatus 100 of FIG. 1. The subject display 140 and the image capture device 145 are located on the back side of the flip housing 205. A speaker device 305 can be on the back side of the flip housing 205. One or more mechanisms for providing one or more prompts (not shown) can also be located in the base housing 210 of the flip-type cellular telephone or alternatively in the flip housing 205 of the flip-type cellular telephone.

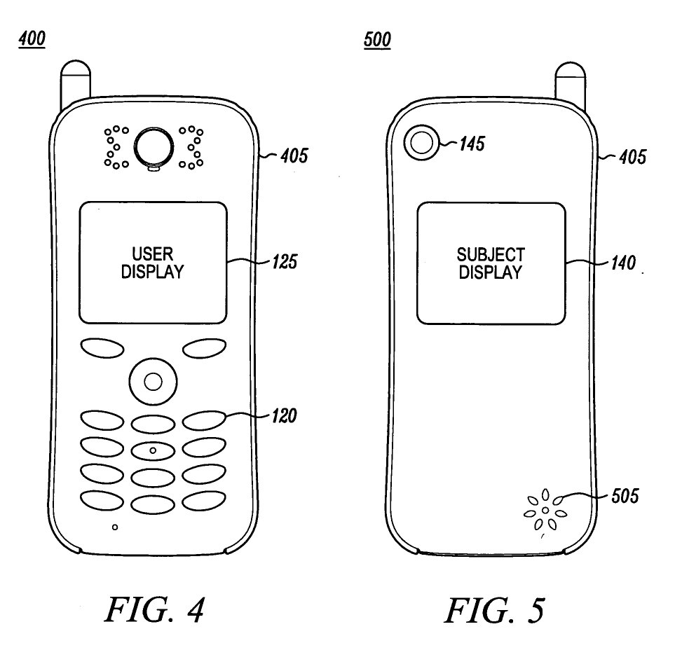

Referring to FIGS. 4 and 5, an exemplary embodiment of a fixed-type communication device suitable for integration with the interactive imaging apparatus 100 is shown. Specifically, FIG. 4 illustrates a front view 400 of a fixed-type communication device and FIG. 5 illustrates a back view 500 of a fixed-type communication device. The fixed-type communication device, as illustrated, includes a housing 405 for covering, protecting and supporting the internal components encased within Such as printed circuit boards (PCBs) with electronic components, audio devices, cameras, visual displays, and the like.

By way of example, FIG. 4 illustrates a front view 400 of a fixed housing cellular telephone incorporating the interactive imaging apparatus 100 of FIG. 1. In this example, the user display 125 and the user interface 120 (i.e. a keypad) are located on the front of the fixed housing cellular telephone.

Further detailing the example, FIG. 5 illustrates a back view 500 of a fixed housing cellular telephone incorporating the interactive imaging apparatus 100 of FIG. 1. The subject display 140, the image capture device 145, and a speaker device 505, are located on the back side of the fixed housing cellular telephone. One or more mechanisms for providing one or more prompt (not shown) can also be located within the fixed housing 405.

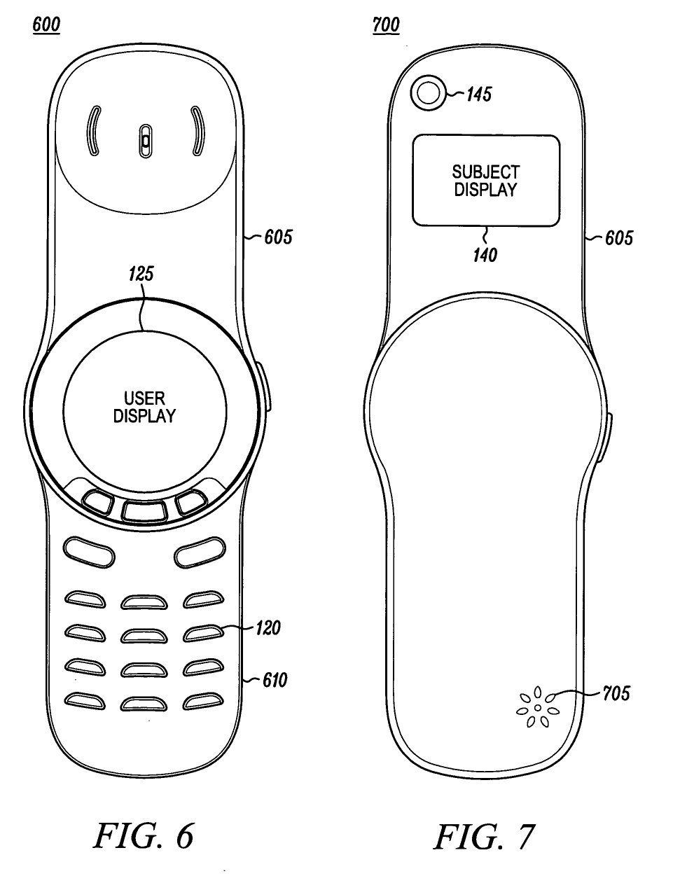

Referring to FIGS. 6 and 7, an exemplary embodiment of a portable blade-type communication device suitable for integration with the interactive imaging apparatus 100 is shown. Specifically, FIG. 6 illustrates a front view 600 of a portable blade-type communication device and FIG. 7 illustrates a back view 700 of a portable blade-type communication device. As illustrated, the blade-type communication device comprises a base housing 610 and a rotating blade housing 605. The rotating blade housing 605 preferably is mechanically coupled to the base housing 610 such that the rotating blade housing 605 revolves in a plane parallel to the base housing 610 for opening and closing of the blade-type communication device. When the blade-type communication device is in use, the two planar elements can be opened in relation to each other, exposing such elements as a keypad; microphone and/or speaker (not shown). When the blade-type communication device is not in use, the two planar elements can be closed and lie in parallel (not shown).

It will be appreciated by those of ordinary skill in the art that the base housing 610 and the blade housing 605 can each have, and/or contain printed circuit boards (PCBs) with electronic components, audio devices, cameras, visual displays, and housing chassis, as well as wiring to connect the electrical component together to form electrical circuits, and the like.

By way of example, FIG. 6 illustrates a front view 600 of a blade-type cellular telephone incorporating the interactive imaging apparatus 100 of FIG. 1. In this example, the user display 125 is located on the front of the rotating blade 605 and the user interface (such as a keypad) 120 is located on the base housing 610.

Further detailing the example, FIG. 7 illustrates a back view 700 of a blade-type cellular telephone incorporating the interactive imaging apparatus 100 of FIG. 1. The subject display 140, the image capture device 145, and a speaker device 705 are located on the back of the rotating blade 605. One or more mechanisms for providing one or more prompts can also be located within the base housing 610 of the blade-type cellular phone or alternatively can be located within the rotating blade housing 605.

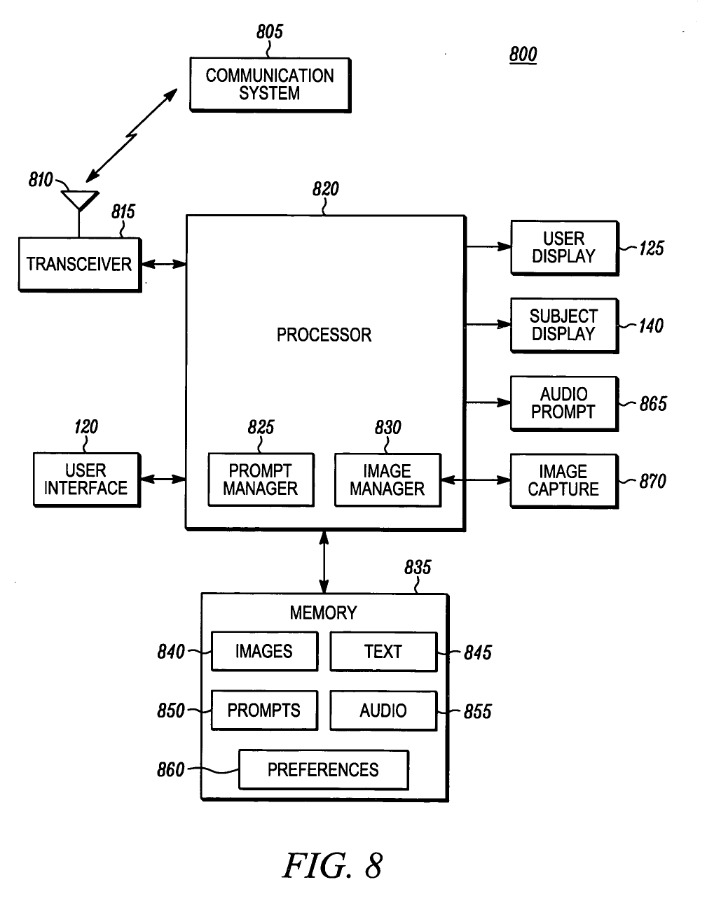

Referring to FIG. 8, an exemplary electrical block diagram of a portable electronic device is shown. Specifically, FIG. 8 illustrates a communication device 800 incorporating the interactive imaging apparatus 100 of FIG. 1 in accordance with the present invention.

The communication device 800, for example, operates within a communication system 805. The communication system 805 can include any wireless radio frequency (RF) channel, for example, a two-way messaging channel, a mobile cellular telephone channel, or a mobile radio channel. The communication system 805, for example, can include a Wireless Local Area Network (WLAN) system, a Third Generation (3G) Code Division Multiple Access (CDMA) or Global System for Mobile communication (GSM) system, or combinations or future versions of these systems. Similarly, it will be appreciated by one of ordinary skill in the art that one or more of the communication systems can function utilizing other types of wireless communication channels such as infrared channels and/or Bluetooth channels. Similarly, it will be appreciated by one of ordinary skill in the art that one or more of the communication systems can function utilizing a wire line communication channel such as a local area network (LAN) or a wide area network (WAN) or a combination of both. In the following description, the term “communication system” refers to any combination of the communication systems mentioned herein or an equivalent.

The communication device 800, by way of example only, is embodied in a cellular radiotelephone having a conventional cellular radio transceiver circuitry, as is known in the art, and will not be presented here for simplicity. Although the invention is illustrated herein with reference to a cellular radiotelephone, the invention is alternatively applied to other communication devices such as, for example, messaging devices, personal digital assistants and personal computers with communication capability, mobile radio handsets, cordless radiotelephone and the like.

Referring back to FIG. 8, the communication device 800 includes an antenna 810 and a transceiver 815 for the receipt of signals transmitted from the communication system 805 to the communication device 800; and for the transmission of signals from the communication device 800 to the communication system 805. The antenna 810 intercepts transmitted signals from one or more communication networks and transmits signals to the one or more communication networks. For example, the antenna 810 and transceiver 815 can operate at 1.9 GHz (gigahertz) on a PCS (Personal Communication Services) Band. The antenna 810 is coupled to the transceiver 815, which employs conventional demodulation techniques for receiving the communication signals. The transceiver 815 is coupled to the processor 820 and is responsive to commands from the processor 820. When the transceiver 815 receives a command from the processor 820, the transceiver 815 sends a signal via the antenna 810 to one or more of the communication systems.

In an alternative embodiment (not shown), the communication device 800 includes a receive antenna and a receiver for receiving signals from one or more of the communication systems and a transmit antenna and a transmitter for transmitting signals to one or more of the communication systems. It will be appreciated by one of ordinary skill in the art that other similar electronic block diagrams of the same or alternate type can be utilized for the communication device 800.

Coupled to the transceiver 815 is the processor 820 utilizing conventional signal-processing techniques for processing received messages. It will be appreciated by one of ordinary skill in the art that additional processors can be utilized as required to handle the processing requirements of the processor 820. The processor 820 decodes an identification in the demodulated data of a received message and/or voice communication, compares the decoded identification with one or more identifications stored in a memory 835, and when a match is detected, proceeds to process the remaining portion of the received message and/or voice communication. The one or more identifications, for example, can be a unique selective call address assigned within a wireless communication system, an electronic mail address, an IP (internet protocol) address or any other similar identification.

The communication device 800 of FIG. 8 further includes a user interface 120 coupled to the processor 820 which enables a user 105 (shown in FIG. 1) to activate a new image mode using an image capture 870. The user interface 120 can, for example, include several keys for performing various functions. Alternatively, the user interface 120 can include a voice response system for providing and/or receiving responses from one or more users. Alternatively, the user interface 120 can include one or more buttons used to generate a button press or a series of button presses such as received from a touch screen display or some other similar method of manual response initiated by the user 105. The user interface 120 couples data signals to other portions of a device, such as the processor 820, based on the keys depressed by the user.

The processor 820 preferably includes a prompt manager 825 and an image manager 830. The prompt manager 825 manages the processing of the various types of alerts resulting in a prompt 135 to an image subject (for example the subject 110 of FIG. 1). The prompt 135, for example, can include an audio alert that is emitted and/or a visual alert which is displayed, or a combination of various other alerts. Specifically, an audible prompt 865 is emitted and a visual prompt is displayed on the user display 125 and/or the subject display 140. The image manager 830 directs the image capture function of the communication device 800. When an image capture 870 of the subject is carried out, the subject image is displayed on the user display 125 and/or the subject display 140. Alternatively, the image manager 830 can be coupled to the processor 820 as a separate module.

It will be appreciated by those of ordinary skill in the art that the image manager 830 and the prompt manager 825 can be hard coded or programmed into the communication device 800 during manufacturing, can be programmed over-the-air upon customer subscription, or can be a downloadable application. It will be appreciated that other programming methods can be utilized for programming the image manager 830 and the prompt manager 825 into the communication device 800. It will be further appreciated by one of ordinary skill in the art that the prompt manager 825 and the image manager 830 can be hardware circuitry within the communication device 800.

To perform the necessary functions of the communication device 800, the processor 820 is operatively coupled to a memory 835, which can include a random access memory (RAM), a read-only memory (ROM), an electrically erasable programmable read-only memory (EEPROM), and flash memory. The memory 835, for example, includes memory locations for the storage of one or more received or transmitted messages, one or more software applications, and the like. In accordance with the present invention, the memory 835 includes storage locations for storing one or more images 840, one or more prompts 850, one or more preferences 860, one or more text 845, and one or more audio 855.

It will be appreciated by those of ordinary skill in the art that the memory 835 can be integrated within the communication device 800, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the communication device 800. The SIM card can be used to transfer a variety of information from/to the communication device 800 and/or any other compatible device.

As illustrated in FIG. 8, the communication device 800 includes at least two displays, identified for exemplary purposes herein as the user display 125 and the subject display 140. The user display 125 and the subject display 140 provide visual information for the operation of the communication device 800 by displaying data such as one or more communication messages, phone numbers, caller identifications, graphic images, text entries, and the like. The user display 125 and the subject display 140 further can be used to display indications of the status of various electronics within the communication device 800. The user display 125 and the subject display 140 further can display graphics such as screen savers, wallpaper, gaming applications, and the like. Similarly, the user display 125 and the subject display 140 can display still image and video images received by the communication device 800, programmed into the communication device, or captured by the communication device itself. It will be appreciated by those of ordinary skill in the art that the user display 125 and the subject display 140 can be a liquid crystal display, a cathode ray tube display, one or more organic light emitting diodes, one or more LEDs, a plasma display, or an equivalent.

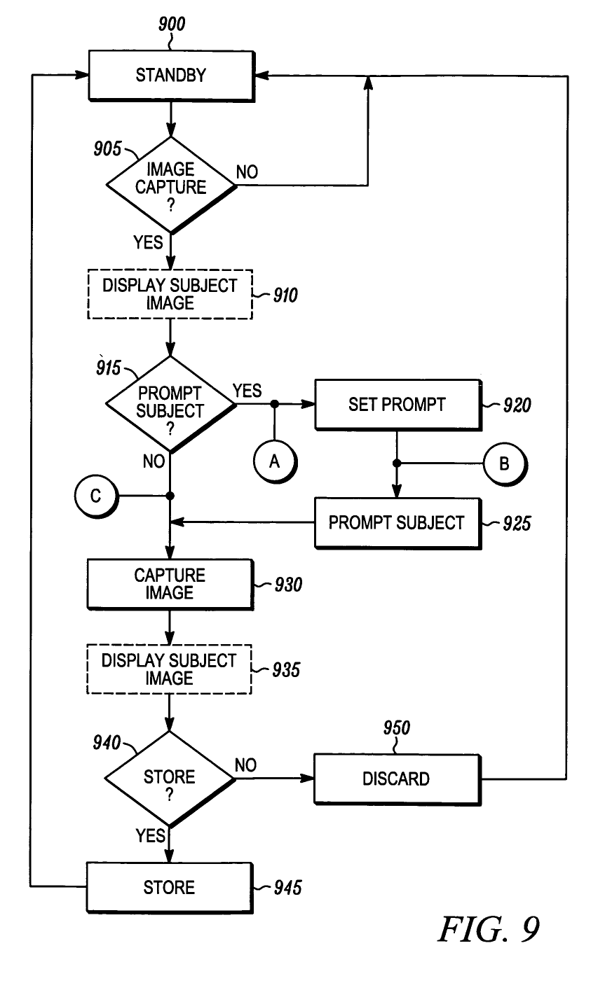

Referring to FIG. 9, a flow chart illustrating one embodiment of the operation of the communication device 800 utilizing the interactive imaging apparatus 100 is shown. The operation of FIG. 9 begins with the communication device 800 in standby mode in step 900. Next, in Step 905, the operation determines whether or not an image capture activation has been detected. The image capture activation, for example, can include the user 105 depressing an image/video button within the user interface 120 and activating a new image capture mode. When image capture is not activated in Step 905, the communication device 800 returns to the standby mode of step 900.

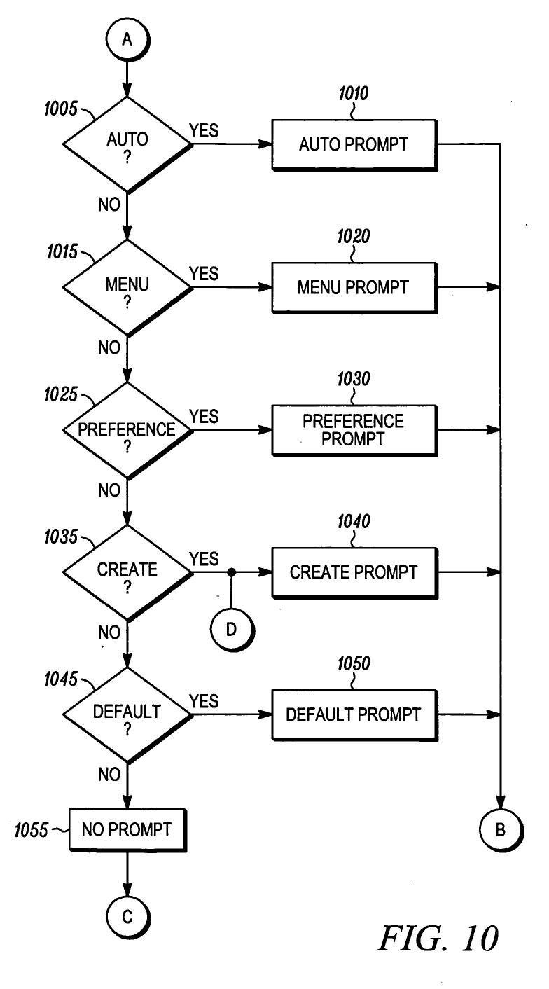

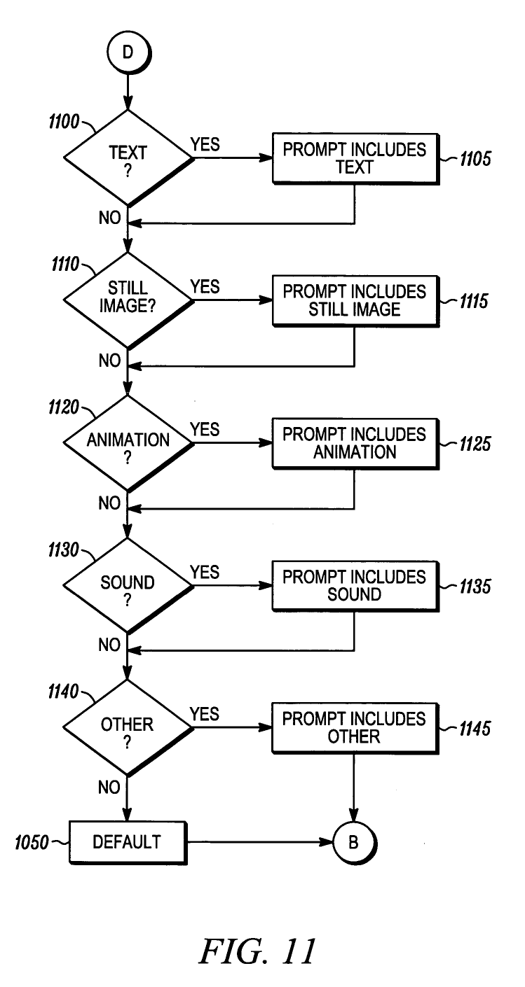

When image capture is activated in Step 905, the operation continues optionally to Step 910, in which the subject image can be displayed on the user display 125 and/or on the subject display 140. Next, and when optional Step 910 is not processed, the operation continues to Step 915, in which the operation determines whether or not a prompt to the image capture subject is requested and/or desired. For example, the operation of Step 915 can include the prompt manager 825 determining whether or not to generate one or more prompts by accessing the preferences 860 in the memory 835 of the communication device 800. When a prompt 135 is desired/required, the operation continues to node A and Step 920 in which a prompt 135 is set. For example, the prompt manager 825 coupled to the memory 835, can set the prompt 135 using a series of operations as detailed in FIGS. 10 and 11. The operation then continues to node B and Step 925 in which the subject is prompted using the set prompt from Step 920. For example, when the prompt 135 includes a visual prompt, the visual prompt can be displayed on the subject display 140. Similarly, when the prompt 135 includes an audible prompt, the audible prompt can be emitted from the audio prompt 865 of the communication device 800.

Next, and when no prompt 135 is desired/required in Step 915, the operation continues to node C and Step 930 in which the subject image is captured (for example, using the image capture 870 of the communication device 800). Next, the operation optionally continues to Step 935 in which the captured subject is displayed on the user display 125 and/or the subject display 140.

Next, in Step 940, the operation determines whether or not to store the captured image. For example, the image manager 830 can detect a request to store the image. The request can begin with the user 105 using the user interface 120 to request to store the captured image. When storing of the captured image is required/desired in step 940, the operation continues to Step 945 in which the image is stored. For example, the image can be stored within the images 840 location in the memory 835. The process then cycles back to standby mode of Step 900. When storing of the captured image is not desired/required in Step 940, the process continues to Step 950 in which the captured image is discarded. For example, the user 105 can use the user interface 120 to discard the captured image in step 950. The process then cycles back to standby mode of step 900.

Referring to FIG. 10, a flow chart further detailing an exemplary operation for choosing one or more prompts to be used in setting the prompt 135 of Step 920 of FIG. 9 is shown. For example, the operation of FIG. 10 can be carried out by the prompt manager 825 coupled with the memory 835 of the communication device 800. The prompt manager 825 matches a desired prompt method based on alerts stored in the memory 835 of the communication device 800. The prompt methods are selected individually or in combination and can include an auto alert in step 1005, a menu alert in step 1015, a preference alert in step 1025, a create alert in step 1035, a default alert in step 1045, or no prompt in step 1055.

The operation begins with node A and then continues to Step 1005 in which the operation determines whether or not an automatic prompt is enabled. For example, the prompt manager 825 can detect a setting requiring an automatic prompt any time a prompt is being set. When an automatic prompt is enabled in step 1005, the auto prompt method in step 1010 is enabled. The auto prompt method in step 1010, for example, can include one or more prompts pre-selected by the user 105 to automatically be utilized every time the prompt subject request is processed in step 915 of FIG. 9.

When an automatic prompt is not enabled in Step 1005, the operation continues to Step 1015 in which it is determined whether or not a menu prompt method is enabled. When the menu alert in step 1015 is detected, a menu prompt method in step 1020 is activated. The user interface 120 can be used to access the menu options which the user then can select from to set one or more prompts. It will be appreciated by those of ordinary skill in the art that the auto prompt method in step 1010 can be combined with the menu prompt method in step 1020 to set the prompt in step 920 of FIG. 9 (not shown).

When the menu prompt method is not selected in Step 1015, the operation continues to Step 1025 in which it is determined whether or not a preference prompt method is enabled. When the preference prompt method is detected, a preference prompt method in step 1030 is activated. The preference prompt method in step 1030 allows the user 105 to access preset alert combinations for specific conditions, a particular subject, or the like. For example, the preference prompt method in step 1030 can give the user 105 options for setting prompts based on factors such as time of day, weather, geographic location, and the like. The preset alerts can include bits of audio, animation, and text, or the like which are stored individually or in combination in the preferences 860 of the memory 835 of the communication device 800. It will be appreciated by those of ordinary skill in the art that the preference prompt method in step 1030 can be combined with either or both of the menu and auto prompt methods (not shown).

When the preference alert request is not detected in Step 1025, the operation continues to Step 1035 in which it is determined whether or not a create prompt operation is enabled. When the create prompt in step 1035 is enabled, a create prompt method in step 1040 is activated. The create prompt method in step 1040 allows the user 105 to create a prompt or combination of prompts specific to the particular instance of a subject image is being captured. For example, the prompt manager 825 accesses information from the memory 835 of the communication device 800 and provides options for creating a prompt. The various options are detailed further in FIG. 11 (starting at node D). It will be appreciated by those of ordinary skill in the art that the create prompt method in step 1040 can be combined with each or all of the auto, menu, and preference prompt methods (not shown).

When the create alert request is not processed in Step 1035, the operation continues with Step 1045 in which it is determined whether a default prompt has been pre-set/stored. When the default prompt has been pre-set and/or stored, a default prompt method in step 1050 is enabled. The default prompt method in step 1050 can be used to set a prompt when the other prompt methods are not desired or are not processed. The default prompt method in step 1050 can be a prerecorded or preprogrammed alert or combination of alerts. When the default alert is not processed, then there is no prompt request as in step 1055 and the operations cycle back to the steps at node C, in which the image capture 870 proceeds without a prompt 135. All prompt methods can be combined, as indicated by node B, to prompt the subject. If no prompt is created as in step 1055, the image capture 870 proceeds without the prompt 135 at node C.

Referring to FIG. 11, a flow chart detailing the available options of the create prompt method in step 1040 of FIG. 10 is shown. Specifically, the create prompt method in step 1040 of FIG. 10 which is represented by node D is illustrated in FIG. 11. Various types of alerts stored in the memory 835 of the communication device 800 are accessed at node D. The various types of prompts, for example, can take the form of text in step 1100, still image in step 1110, animation in step 1120, sound in step 1130, or other in step 1140. A prompt 135 can include an audible alert such as a speaker (not shown) with associated speaker drive circuitry capable of playing melodies and other audible alerts. The prompt 135 similarly can include a tactile alert such as a vibrator (not shown) with associated vibrator drive circuitry capable of producing a physical vibration. The prompt 135 similarly can include a visual alert such as one or more light emitting diodes (LEDs) (not shown) with associated LED drive circuitry and/or a visual display with associated display drive circuitry, each capable of producing a visual alert. The prompt 135 similarly can include a haptic alert capable of producing a haptic output (not shown) such as a scent. It will be appreciated by one of ordinary skill in the art that other similar alerting means as well as any combination of the audible, vibratory, visual, and haptic alert outputs herein described can be used for the prompt 135.

The operation of FIG. 11 begins with Step 1100, in which it is determined whether or not the prompt 135 being created will include text. When a text alert is desired in step 1100, text is included within the prompt in step 1105. The text can be retrieved from the text 845 stored in the memory 835 or alternatively can be created by the user using the user interface 120. Text can include any of the letters of the alphabet, phrases, words, numbers, and the like, and is not limited to the English language or other Western languages, but can also include languages such as Japanese, Chinese or the Cyrillic alphabet.

When text alert is not desired in step 1100, the operation continues to Step 1110 in which it is determined whether or not the prompt 135 being created will include still image. When still image is desired in Step 1110, still image is included within the prompt 135 in step 1115. The utilized still image can be retrieved from the images 840 stored in the memory 835, or alternatively can be obtained by the user using the user interface 120. For example, in devices having web access, one or more still images can be retrieved from the Internet. Still images can include symbols, pictograms, icons, photographs, and the like.

When still image is not desired in step 1110, the operation continues to Step 1120 in which it is determined whether or not the prompt 135 being created will include animation. When animation is desired, animation is included within the prompt 135 in step 1125. Animation control signals can create the illusion of movement of an image or a portion of an image, change display characteristics of all or part of the image (e.g., flashing the display or highlighting or changing a color), or otherwise affect the virtual image or its displayed surroundings. Thus, the term “animation” as used herein includes both “animating” and “exciting” as the terms are used in the MPEG4 (Moving Picture Experts Group) standard. It will be appreciated by those of ordinary skill in the art that “animation” can depend on movement captured by a video source or can be controlled using one or more user interface components such as a keypad having one or more buttons used to generate a button press or a series of button presses, a joystick, a trackball, a voice response system or other similar method of receiving an input initiated by the device user. For example, when a video source captures a nodding head movement, it can be translated into a nodding animation. Alternatively, a user can manually implement a nodding animation without actually nodding into a camera or other video source.

When animation is not desired in step 1120, the operation continues to Step 1130 in which it is determined whether or not the prompt 135 being created will include sound. When sound is desired in Step 1120, sound is included in the prompt 135 in step 1135. The utilized sound can be retrieved from the audio 855 stored in the memory 835 or alternatively can be obtained by the user using interconnections to audio devices such as MP3 players and personal computers.

When sound is not desired in Step 1130, the operation continues to Step 1140 in which it is determined whether or not the prompt 135 being created will include any other alert. When another alert is desired in step 1140, the alert is included within the prompt 135 in step 1145. Other alerts can include a vibratory alert, a haptic alert, or the like. When no other alert is desired, the remaining option is the default alert in step 1045 as described in FIG. 10. Next, the resulting prompt 135 can include a combination of all these alerts as indicated at node B.

While this disclosure includes what are considered presently to be the preferred embodiments and best modes of the invention described in manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. An interactive imaging apparatus comprising:
a user interactive component;
a subject interactive component for providing one or more prompts to a subject in response to a prompt command from the user interactive component; and
an image capture device coupled between the user interactive component and the subject interactive component, for capturing a subject image in response to an image capture command from the user interactive component.

2. An interactive imaging apparatus as recited in claim 1, wherein the user interactive component comprises:
a user interface for receiving a first user input to generate the prompt command and a second user input to generate the image capture command.

3. An interactive imaging apparatus as recited in claim 2, wherein the user interactive component further comprises:
a user display for displaying the captured subject image.

4. An interactive imaging apparatus as recited in claim 1, wherein the one or more prompts engage the attention of the subject prior to the capturing of the subject image.

5. An interactive imaging apparatus as recited in claim 1, wherein the subject interactive component comprises:
the one or more prompts; and
a subject display having a first portion for displaying one or more operational indications.

6. An interactive imaging apparatus as recited in claim 5, wherein the subject display further includes a second portion for displaying at least one of the one or more prompts.

7. An interactive imaging apparatus as recited in claim 6, wherein the one or more prompts is selected from a group comprising a textual prompt, an iconic prompt, a still image prompt, and an animated image prompt.

8. An interactive imaging apparatus as recited in claim 1, wherein the one or more prompts is selected from a group comprising an audio prompt, a visual prompt, a vibratory prompt, and a haptic prompt.

9. A method of operation of an interactive imaging apparatus comprising the steps of:
generating one or more prompts to engage the attention of a subject image; and
activating an image capture of the subject image.

10. A method of operation as recited in claim 9, wherein the generating step comprises generating one or more prompts selected from a group comprising a textual prompt, an iconic prompt, a still image prompt, and an animated image prompt.

11. A method of operation as recited in claim 9, further comprising the step of:
displaying the subject image on a user display.

12. A method of operation as recited in claim 11, further comprising the step of:
displaying the subject image on a subject display.

13. A method of operation as recited in claim 12, wherein the one or more prompts includes a visual prompt, the method further comprising:
displaying the visual prompt on the subject display.

14. A method of operation as recited in claim 9, wherein the one or more prompts includes a visual prompt, the method further comprising:
displaying the visual prompt on a first portion of the subject display; and
displaying an operational indication on a second portion of the subject display.
